(19) United States
(12) Patent Application Publication
(10) Pub. No.: US 2012/0113942 A1
(43) Pub. Date: May 10, 2012

(54) UPLINK RECEIVING METHOD FOR A BASE STATION AND UPLINK TRANSMITTING METHOD FOR A TERMINAL USING A SHARED WIRELESS RESOURCE

(75) Inventor: Jae Heung Kim, Daejeon (KR)

(73) Assignee: Electronics and Telecommunications Research Institute, Daejeon (KR)

(21) Appl. No.: 13/382,730

(22) PCT Filed: Jul. 5, 2010
(86) PCT No.: PCT/KR2010/004349

§ 371 Date: Jan. 6, 2012

(30) Foreign Application Priority Data
Jul. 8, 2009 (KR) 10-2009-0062078
Jan. 6, 2010 (KR) 10-2010-0000760

(51) Int. Cl. H04W 74/04; H04W 72/04

(52) U.S. Cl. 370/329

(57) ABSTRACT

The invention relates to an uplink receiving method for a base station, comprising: a step of transmitting scheduling information for a shared wireless resource to object terminals to which the shared wireless resource is to be allocated, via a downlink control channel using a scheduling identifier; a step of receiving data from at least one terminal from among the object terminals, via the shared wireless resource allocated by the scheduling information; and a step of transmitting data receipt feedback information for at least one terminal which has received data via the shared wireless resource. An uplink transmitting method for a terminal comprises: a step of receiving scheduling information for a shared wireless resource from a base station via a downlink control channel; a step of transmitting data via the shared wireless resource allocated by the scheduling information; and a step of receiving, from the base station, feedback information which indicates whether or not the data transmitted via the shared wireless resource has been successfully received. Consequently, uplink transmission procedures between the terminal and the base station are integrated and simplified to reduce uplink transmission latency.

### TECHNICAL FIELD

The present invention relates in general to an uplink transmission method of a terminal and an uplink reception method of a base station in a cellular system, and more specifically to an uplink transmission method of a terminal and an uplink reception method of a base station using shared radio resources which can reduce an uplink transmission delay.

### BACKGROUND ART

In a conventional cellular system, dedicated radio resources are allocated to a random terminal.

In other words, in a circuit-based cellular system, when a communication connection for data exchange between a terminal and a base station is set, a dedicated channel is allocated to enable data transmission regardless of whether or not there is data to be transmitted by the terminal.

Also in a packet-based orthogonal frequency division multiplexing (OFDM) (or orthogonal frequency division multiple access (OFDMA)) cellular system, such as a third generation partnership project (3GPP) long term evolution (LTE) system, when a communication connection for data exchange between a terminal and a base station is set, dedicated uplink radio resources (e.g., a transmission frequency carrier and transmission time) are allocated to a terminal in chronological order according to a buffer status report transmitted by the terminal or a set service type, so that the terminal can exclusively use the dedicated uplink radio resources.

However, LTE systems which are continuously being standardized additionally require performance improvement, and in particular, various methods for reducing a transmission delay are being examined. These methods include optimization of a wireless protocol structure, minimization of wireless packet service data unit (SDU)/protocol data unit (PDU) division, etc., and efficient buffer status report of a terminal is also being examined as one of the methods.

In a wideband code division multiple access (WCDMA) system, when one dedicated code and uplink transmission power are allocated to a terminal, a terminal can adjust a modulation and coding scheme (MCS) level according to the range of the allocated transmission power and the amount of data in the transmission buffer of the terminal to transmit the data. On the other hand, in an OFDM(A) cellular system, a base station allocates uplink radio resources and also sets an MCS level of a terminal according to a reported buffer status of the terminal. Since the base station sets the amount of data to be transmitted by the terminal, it is important for the terminal to report a buffer status, and the terminal is required to report the buffer status frequently so that the base station knows the accurate buffer status of the terminal.

However, multiple terminals are within the service area of the base station and provided with various packet services, and thus it is difficult for the base station to know the accurate buffer status of the terminals. Also, uplink radio resource allocation of the base station should follow the buffer status report of the terminals, and thus has basic latency.

Consequently, it is necessary to reduce an uplink transmission delay by improving a basic uplink radio resource allocation scheme including an uplink radio resource request of a terminal, uplink radio resource allocation of a base station, a buffer status report of the terminal, uplink radio resource allocation of the base station, packet information transmission of the terminal, and so on.

### DISCLOSURE

### Technical Problem

Accordingly, example embodiments of the present invention are provided to substantially obviate one or more problems due to limitations and disadvantages of the related art.

Example embodiments of the present invention provide an uplink reception method of a base station using a shared allocation scheme capable of reducing an uplink transmission delay by improving a scheduling process of uplink transmission resources.

Example embodiments of the present invention also provide an uplink transmission method of a terminal using a shared allocation scheme capable of reducing an uplink transmission delay by improving a scheduling process of uplink transmission resources.

### Technical Solution

In some example embodiments, a method of allocating radio resources for uplink transmission and performing uplink reception using radio resources shared by at least one terminal includes: a scheduling information transmitting operation of transmitting scheduling information on the shared radio resources to shared radio resource allocation target terminals through a downlink control channel using a scheduling identifier; a data receiving operation of receiving data from at least one of the target terminals using the shared radio resources according to the scheduling information; and a feedback transmitting operation of transmitting data reception feedback information on the at least one terminal of which the data is received using the shared radio resources.

Here, the scheduling identifier may be one of a unique identifier given to each of the target terminals, a unique identifier allocated to a group of some of the target terminals, and an identifier reserved for shared allocation.

The scheduling identifier may indicate a modulation and coding scheme (MCS) level of data that the target terminals transmit using the shared radio resources or a range of the MCS level, or the scheduling information may include information indicating the MCS level of the data that the target terminals transmit using the shared radio resources or the range of the MCS level. When the scheduling identifier indicates the range of the MCS level of the data transmitted using the shared radio resources, or the scheduling information includes the information indicating the range of the MCS level of the data transmitted using the shared radio resources, the data receiving operation may include performing blind demodulation and decoding on the received data from the shared radio resources within the range of the MCS level of the data.

When the data is successfully received from the at least one terminal, the feedback transmitting operation may include transmitting a signal indicating that the data is successfully received from the at least one terminal using an ACK signal of a downlink physical hybrid automatic repeat request (HARQ) indicator channel (PHICH). Here, the feedback transmitting operation may further include transmitting information for designating the terminal transmitting the successfully received data separately from the ACK signal of the downlink PHICH.

When the data is successfully received from the at least one terminal, the feedback transmitting operation may include transmitting information for designating the terminal transmitting the successfully received data together with a signal indicating that the data is successfully received from the at least one terminal using at least one of a physical downlink control channel (PDCCH) region and a physical downlink shared channel (PDSCH) region.

In other example embodiments, a method for a terminal to have radio resources for uplink transmission allocated and perform uplink transmission using radio resources shared by at least one terminal includes: a scheduling information receiving operation of receiving scheduling information on the shared radio resources from a base station through a downlink control channel using a scheduling identifier; a data transmitting operation of transmitting data using the shared radio resources according to the scheduling information; and a feedback receiving operation of receiving feedback on whether or not the data transmitted using the shared radio resources is successfully received from the base station.

Here, the scheduling identifier may be one of a unique identifier given to the terminal, a unique identifier allocated to a plurality of terminals including the terminal, and an identifier reserved for shared allocation.

The scheduling identifier may indicate an MCS level of data that the terminal transmits using the shared radio resources or a range of the MCS level, or the scheduling information may include information indicating the MCS level of the data that the terminal transmits using the shared radio resources or the range of the MCS level.

The data transmitting operation may include transmitting a unique identifier allocated to the terminal together with the data using the shared radio resources according to the scheduling information.

When the data transmitted by at least one terminal is successfully received by the base station, the feedback receiving operation may include receiving the feedback using an ACK signal of a downlink PHICH from the base station. Here, the feedback receiving operation may further include receiving information for designating the terminal transmitting the successfully received data separately from the ACK signal of the downlink PHICH.

When the data transmitted by at least one terminal is successfully received, the feedback receiving operation may include receiving, from the base station, information for designating the terminal transmitting the successfully received data together with a signal indicating that the data is successfully received from the at least one terminal using at least one of a PDCCH region and a PDSCH region.

### Advantageous Effects

Accordingly, processes such as an uplink radio resource request between a terminal and a base station, a buffer status report, and uplink radio resource allocation are integrated and reduced so that an uplink transmission delay can be reduced.

### DESCRIPTION OF DRAWINGS

FIG. 1 is a conceptual diagram showing the constitution of one scheduling period including a downlink control channel and radio resources for data transmission to describe the present invention;

FIG. 2 is a conceptual diagram showing the constitution of one scheduling period including an uplink control channel and radio resources for data transmission to describe the present invention;

FIGS. 3 and 4 are conceptual diagrams illustrating a first shared allocation feedback information transmitting method and second shared allocation feedback information transmitting method according to an exemplary embodiment of the present invention;

FIG. 5 is a frame timing diagram illustrating an uplink reception method of a base station and an uplink transmission method of a terminal according to an exemplary embodiment of the present invention;

FIG. 6 is a conceptual diagram illustrating an example of the constitution of a system bandwidth including a band for shared allocation when the system bandwidth is constituted of fragmented bandwidths;

FIG. 7 is a flowchart illustrating an uplink reception method of a base station according to an exemplary embodiment of the present invention; and

FIG. 8 is a flowchart illustrating an uplink transmission method of a terminal according to an exemplary embodiment of the present invention.

### MODES OF THE INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station, mobile terminal, user equipment (UE), user terminal (UT), wireless terminal, access terminal (AT), terminal, subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units, terminals or machines having a combination of such functions, but are not limited to these.

The term “base station” used herein generally denotes a fixed point communicating with a terminal, and may be referred to as a Node-B, evolved Node-B (eNB), base transceiver system (BTS), access point, and other terms.

Hereinafter, exemplary embodiments of the present invention will be described with reference to the appended drawings.

In a packet-based cellular system, uplink occupation of a terminal may vary according to the type or form of a provided service. A terminal that continuously or intermittently transmits data occupies a part of an uplink control channel and can transmit a wireless channel quality report, feedback information for a downlink, uplink radio resource request information, and so on.

However, even among terminals whose connection with a base station is set, terminals performing a low power consumption operation, that is, discontinuous reception (DRX) in which a downlink control channel alone is periodically monitored to reduce power consumption of a terminal, may not be able to use resources of any uplink control channels because uplink radio resource allocation is released.

In particular, in orthogonal frequency division multiplexing (OFDM) (or orthogonal frequency division multiple access (OFDMA)) cellular systems, uplink physical layer synchronization needs to be maintained to ensure uplink orthogonality between terminals. Thus, a terminal which does not perform uplink transmission for a predetermined time or more cannot receive transmission timing adjustment information for maintaining uplink physical layer synchronization from a base station, and needs to achieve uplink physical layer synchronization to transmit information on an uplink. To this end, in general, a random access process should be performed.

In a packet-based cellular system, a terminal is uniquely identified using a scheduling identifier allocated by a base station, and uplink and downlink radio resources are allocated using such a scheduling identifier. Thus, an uplink transmission delay additionally occurs.

Exemplary embodiments of the present invention relate to an uplink reception method of a base station using shared radio resources and an uplink transmission method of a terminal using shared radio resources. Prior to these methods, uplink and downlink radio resources of third generation partnership project (3GPP) long term evolution (LTE) will be described. In this specification, descriptions will be made on the basis of uplink/downlink radio resources of 3GPP LTE and control information transmitting/receiving and scheduling methods, but the spirit of the present invention can also be applied to cellular communication systems other than 3GPP LTE.

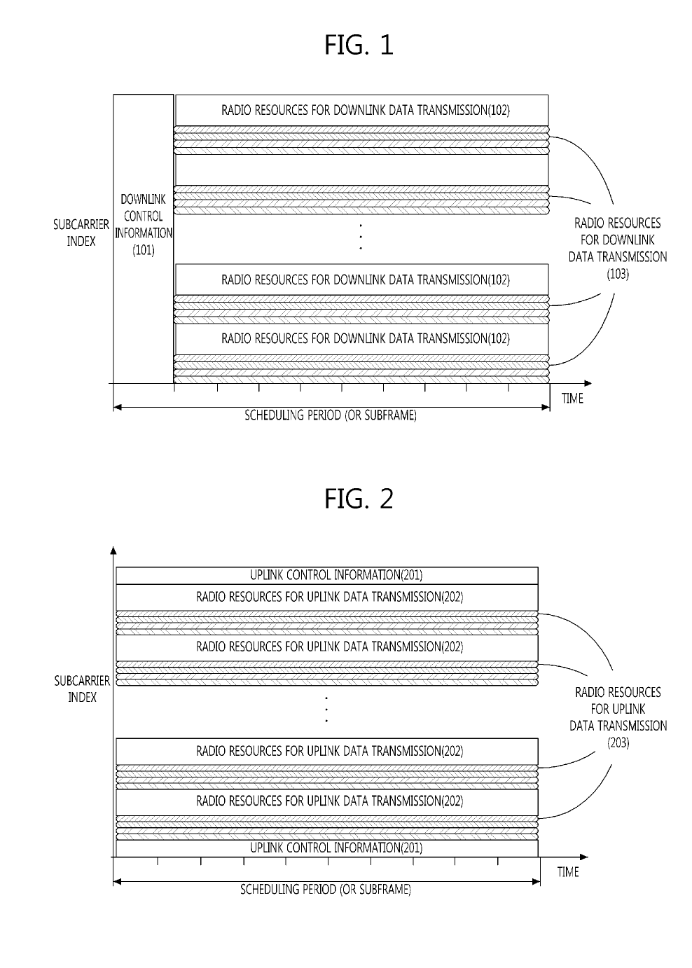

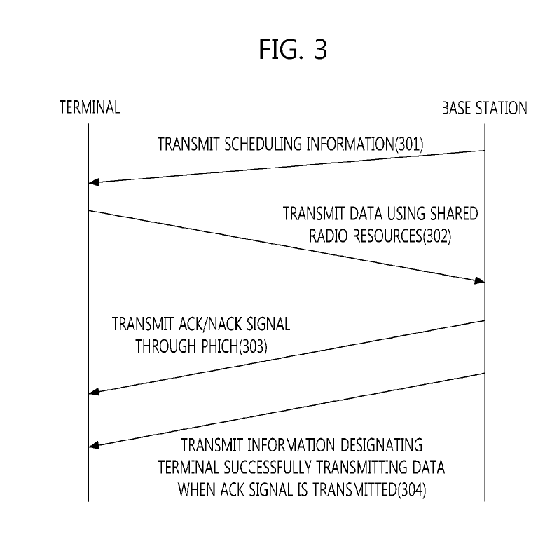

FIG. 1 is a conceptual diagram showing the constitution of one scheduling period including a downlink control channel and radio resources for data transmission to describe the present invention, and FIG. 2 is a conceptual diagram showing the constitution of one scheduling period including an uplink control channel and radio resources for data transmission to describe the present invention.

In other words, FIGS. 1 and 2 show the constitution of downlink and uplink control channels and radio resources for data transmission within one scheduling period. In LTE, one scheduling period may be one subframe.

Referring to FIG. 1, downlink radio resources basically include downlink control information 101, which is a radio resource for control information transmitted on a downlink, and radio resources 102 and 103 for downlink data transmission, which are radio resources for a base station to transmit user data to a terminal.

The downlink control information 101 basically includes downlink scheduling information and uplink scheduling information.

The downlink scheduling information transmitted as the downlink control information 101 includes radio resource allocation information indicating to which terminal or terminal group the radio resources 102 and 103 for downlink data transmission are allocated and a modulation and coding scheme (MCS) level, and is transmitted as control information for a terminal to receive the corresponding radio resources.

Also, the uplink scheduling information in the downlink control information 101 includes information indicating to which terminal uplink radio resources are allocated and at which MCS level the uplink radio resources need to be transmitted.

Referring to FIG. 2, uplink radio resources also basically include uplink control information 201, which is a radio resource for control information transmitted on an uplink, and radio resources 202 and 203 for uplink data transmission, which are radio resources for a terminal to transmit user data to a base station.

The uplink control information 201 is a radio resource for transmitting ACK/NACK feedback information on a downlink, a channel quality report, resource request information indicating that uplink resources are needed, control information for multiple-input multiple-output (MIMO) transmission, etc. The radio resources 202 and 203 for uplink data transmission are intended to transmit a data packet of a terminal, and allocated to the terminal by a base station using the uplink scheduling information in the downlink control information 101 of FIG. 1.

However, when a base station allocates the radio resources 202 or 203 for uplink data transmission to a terminal, uplink control information may be transmitted using the allocated radio resources 202 or 203 for uplink data transmission without occupying resources for the uplink control information 201. Control information may be transmitted on an uplink using the resources for the uplink control information 201 only when the terminal is not allocated the radio resources 202 or 203 for the uplink data transmission. Also, according to a system setting, the radio resources 202 or 203 for uplink data transmission and the uplink control information 201 can be transmitted together.

Terminal-specific allocation information on the radio resources for the uplink control information 201 is implicatively set by downlink control information allocation and allocation of radio resources for downlink data transmission.

As described above, dedicated uplink radio resources are allocated to a terminal according to uplink scheduling information transmitted by a base station in a scheduling period, and exclusively occupied by the terminal to transmit uplink information.

Operation of Cellular System According to Present Invention

In a cellular system according to an exemplary embodiment of the present invention, a base station allocates uplink radio resources to terminals which maintain uplink physical layer synchronization with a base station in sequence, or randomly selects a terminal and allocates uplink radio resources to the selected terminal, so that the terminal can be controlled to report control information such as a buffer status of the terminal without an uplink radio resource request process or to transmit uplink packet data. Thus, an uplink transmission delay can be reduced by omitting a status report process, a radio resource allocation process, etc. required for uplink transmission.

Meanwhile, a base station having a small service area or a base station which does not need uplink physical layer synchronization due to a specific setting (e.g., when a base station has a small cell radius such as a femtocell, and propagation delays of all terminals in the service area are within one cyclic prefix (CP) period of an OFDM symbol) can select a terminal in sequence or randomly and allocate uplink radio resources for sharing to the selected terminal in the above-mentioned method regardless of whether or not uplink synchronization is maintained.

In other words, the base station allocates uplink radio resources to target terminals in sequence or to randomly selected terminals. When a terminal is randomly selected, the base station allocates uplink radio resources to the terminal among target terminals according to a standard randomly selected or set by the base station. For actual shared allocation of uplink radio resources, the above-mentioned sequential scheme and random selection scheme may be combined.

Shared allocation target terminals can be selected from terminals satisfying one or a combination of conditions shown in Table 1 below. Besides these conditions shown in Table 1, uplink radio resources can be allocated for sharing according to a condition set by the base station.

TABLE 1
Example of Shared Allocation Target Terminals

A terminal which has not been allocated uplink radio resources
for a predetermined time
A terminal which has not requested uplink radio resources for a
predetermined time
A terminal whose buffer status report was made a predetermined
time ago
A terminal which is being provided with a plurality of services
A terminal in a poor wireless channel environment
A terminal which is providing a service requiring high
transmission speed

At this time, uplink radio resources can be allocated for sharing to a terminal according to scheduling information transmitted through a physical downlink control channel (PDCCH) using one of the following methods of using a scheduling identifier (e.g., a cell radio network temporary identifier (C-RNTI)):
A) a method using a unique scheduling identifier allocated to a terminal,
B) a method using a group scheduling identifier for multiple allocation intended for multiple terminals, and
C) a method using a scheduling identifier informing of shared allocation (a scheduling identifier dedicated to shared allocation and set in advance to be used by shared allocation target terminals in common).

As the group scheduling identifier for multiple allocation of method B) or the shared allocation scheduling identifier of method C), a part of scheduling identifiers for identifying terminals within the service area of the base station may be reserved for allocation. The information may be reported to all terminals using system information broadcast to the entire service area of the base station, or a group scheduling identifier for multiple allocation or shared allocation scheduling identifier may be set by a control message (e.g., a control message exchanged through a signaling radio bearer (SRB) of the current 3GPP standard, or a radio resource control (RRC) message exchanged for initial data radio bearer (DRB) setting) according to a terminal or a terminal group when a connection between the base station and the terminal is set.

For shared allocation of uplink radio resources, a system or base station may employ a plurality of group scheduling identifiers for multiple allocation or a plurality of shared allocation scheduling identifiers. Mapping/association relationships between one of the group scheduling identifiers for multiple allocation or the shared allocation scheduling identifiers and a terminal or a terminal group may be determined according to at least one of attributes shown in Table 2 below.

TABLE 2

| | |
|---|---|
| Type and Form of | Multicast/Broadcast Service |
| Provided Service | Unicast Service (voice service, image service, |
| | file download service, game or streaming |
| | service, etc.) |
| Transmission Cycle of | Transmission Time Interval (TTI), Packet Data |
| Provided Service or | Transmission Cycle |
| Resource Allocation | Dynamic Allocation, Persistent Allocation, or |
| Cycle | Semi Persistent Allocation |
| Required QoS of | Received Signal Strength Indicator (RSSI), |
| Provided Service | Received Signal-to-Noise Ratio (SNR), |
| | Signal-to-Interference Ratio (SINR), Eb/No, |
| | Bit Error Rate (BER), Block Error Rate |
| | (BLER), Packet Error Rate (PER), etc. |
| Condition for Base | Center Frequency or Bandwidth of Base |
| Station and Terminal | Station or Terminal |
| | Applied Antenna Technology (the number |
| | of antennas, whether or not MIMO technology |
| | or diversity technology has been applied) |
| | Wireless Environment Condition of Terminal |
| | (channel quality reported by a terminal, path |
| | loss or location between a base station and a |
| | terminal) |
| | MCS Level Setting Condition Parameter |
| | within Service Area of Base Station |
| Operation State of | Connected/Active State or Idle State |
| Terminal | Low Power Consumption Operation (DRX) |
| | Setting Condition in Connected State |
| | Whether or Not Low Power Consumption |
| | Operation Is Performed in Connected State |
| Form or Classification | General Cellular Phone, PDA, Laptop |
| of Terminal | Personal Computer (PC), Complex terminal, |
| | Machine, etc. |
| | Size, Resolution, etc. of Terminal's Display |
| | Transmission Power Grade |

For uplink resource allocation, location information of uplink radio resources and also information on an MCS level to be applied when uplink information is transmitted using the uplink radio resources need to be reported together.

When uplink radio resources are allocated for sharing to one or more terminals, it is impossible to know wireless environments of the terminals, and thus an average MCS level or so appropriate for a plurality of terminals needs to be reported.

To this end, an MCS level may be configured to have a mapping relationship with each of a plurality of group scheduling identifiers for multiple allocation or a plurality of shared allocation scheduling identifiers, thereby indicating an MCS level to be applied when a terminal performs transmission using the scheduling identifier itself. In other words, a plurality of group scheduling identifiers for multiple allocation or a plurality of shared allocation scheduling identifiers may be mapped to different MCS levels respectively, and each scheduling identifier may be set to have at least one mapping relationship with MCS information. This means that one scheduling identifier indicates the range of an MCS level that can be selected by a terminal (this case will be described later).

On the other hand, when transmission is performed using uplink scheduling information transmitted in the general downlink control information 101 shown in FIG. 1, location information on uplink radio resources allocated for sharing and MCS information can be separately transmitted through uplink scheduling information included in downlink control information using the scheduling identifier of method A), B) or C).

At this time, a plurality of pieces of MCS information may be transmitted together, or only a representative value indicating a plurality of MCS levels may be transmitted to express a plurality of pieces of MCS information (this case will be described later).

A mapping or setting relationship between a group scheduling identifier for multiple allocation or a shared allocation scheduling identifier and an MCS level may be reported to terminals within the service area of a base station using system information, or set using a control message according to a terminal or terminal group.

When one or more pieces of MCS information are set for one uplink radio resource allocated for sharing as mentioned above, a base station needs to perform blind demodulation and decoding on the uplink radio resource within the range of a plurality of set MCS levels. It may be difficult for the base station to know an average MCS level for wireless environments of all terminals for shared allocation. This method does not enforce the average MCS level on all the terminals, but allows the terminals using the radio resource allocated for sharing to select an MCS level within the available range and perform transmission. However, when an excessively large MCS level range is set, the base station may have the significant load of blind demodulation and decoding, and thus a trade-off between a range that can be selected by the terminal and a load of the base station is required.

As described above, in the case of method B) and C) other than method A) in which shared uplink radio resources are allocated to only one terminal using the unique scheduling identifier of the terminal, one or more terminals may transmit data using the same uplink radio resources, which may cause a conflict between the terminals and thus needs to be controlled. To solve this problem, when uplink radio resources are allocated to multiple terminals by method B) using a group scheduling identifier, or by method C) using a scheduling identifier informing of shared allocation, the following process is performed:

1) A base station transmits uplink radio resource allocation information using a group scheduling identifier or shared allocation scheduling identifier.

2) A terminal monitoring a downlink control channel checks whether the group scheduling identifier or shared allocation scheduling identifier exists or not.

3) A terminal having packet data or control information to transmit on an uplink transmits the data or control information to the base station using uplink radio resources allocated in operation 2). At this time, the unique identifier of the terminal may be transmitted with the data or control information.

4) The base station receives the uplink radio resources allocated for sharing and transmits information indicating whether or not the uplink radio resources are successfully received on a downlink.

5) The terminal transmitting the packet data or control information on the uplink using the uplink radio resources allocated for sharing checks whether the uplink transmission of the terminal itself is successful or fails using the information indicating whether or not the uplink radio resources are successfully received, which is transmitted by the base station in operation 4), and performs a follow-up process.

In this uplink radio resource allocation method based on shared allocation, one or more terminals can attempt transmission using the same uplink radio resources. Thus, in operation 3) in which packet data or control information is transmitted using uplink radio resources allocated in operation 2), unique information of the terminals (e.g., uniquely allocated scheduling identifiers) can be transmitted together. And, when uplink information is successfully received in operation 4), the base station can know which terminal has transmitted the uplink information.

In operation 4), shared allocation feedback information indicating whether or not uplink transmission using shared radio resources is successful can be transmitted on a downlink as described below.

A first method uses a control channel (e.g., a physical hybrid automatic repeat request (HARQ) indicator channel (PHICH)) through which a base station transmits ACK or NACK feedback information to a terminal in response to conventional uplink transmission. In other words, the base station transmits an ACK feedback when uplink information transmitted by a terminal is successfully received using uplink radio resources allocated for sharing, and transmits a NACK feedback when the uplink information is not successfully received.

The case in which an ACK feedback is transmitted denotes that the base station successfully receives uplink information transmitted by at least one terminal when multiple terminals transmit uplink information. The case in which a NACK feedback is transmitted denotes that uplink information transmission of multiple terminals causes a conflict between the terminals and hinders the base station from successfully receiving uplink information, no terminal transmits uplink information using the corresponding uplink radio resources, or the base station cannot receive uplink information transmitted by only one terminal.

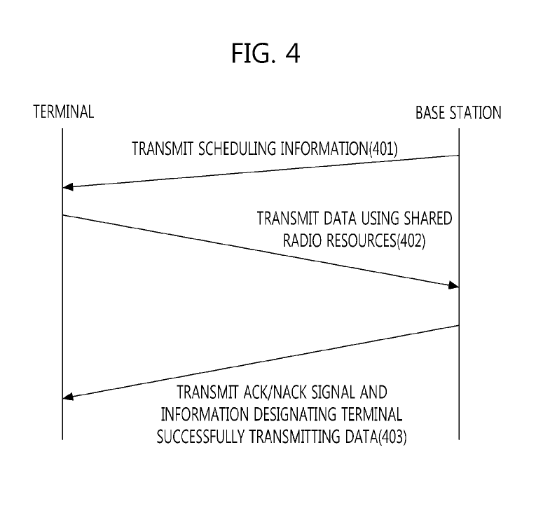

When the base station transmits an ACK feedback, control information indicating which terminal has transmitted received information (i.e., which terminal has transmitted the data successfully received in operation 4)) may need to be transmitted because the same uplink radio resources allocated for sharing can be occupied by multiple terminals and used for transmission. Thus, a terminal using uplink radio resources allocated for sharing can check whether or not the base station successfully receives uplink information transmitted by the terminal itself (see FIG. 3 to be described later).

A second method uses the region (e.g., a media access control (MAC) protocol data unit (PDU)) of a downlink control information transmission channel (101 of FIG. 1; a PDCCH) or radio resources for downlink data transmission (102 and 103 of FIG. 1; a physical data shared channel (PDSCH)) (see FIG. 4 to be described later). When uplink transmission using shared radio resources is successful, feedback information may include identifier information on the corresponding terminal and be transmitted, and at least one piece of feedback control information on shared allocation can be transmitted by one piece of downlink feedback information. Such feedback control information may include at least one of pieces of information shown in Table 3 below.

TABLE 3

Scheduling Identifier Indicating Shared Allocation (one of methods
A), B) and C))
Indexing (or addressing) Information Indicating Shared Allocation
Radio Resources
Terminal's Unique Identifier Transmitted by Terminal (e.g., a
scheduling identifier allocated by a base station)
ACK or NACK Feedback Information
New Shared Allocation Information

When feedback information is constituted of the unique identifier of a terminal successfully received by a base station without ACK or NACK feedback information, and no packet is received using uplink radio resources allocated for sharing by the base station (i.e., the case of reception failure at a base station, the feedback information may not be generated or transmitted. In other words, the base station may transmit feedback information using the unique identifier of a terminal only when a packet is successfully received using uplink radio resources allocated for sharing, thereby reducing signaling overhead as well.

Shared allocation information and downlink feedback information may be transmitted together using a downlink control channel, and shared allocation feedback information may be transmitted using the first and second methods together.

For example, when NACK feedback information is reported by the first method, feedback information cannot be transmitted according to the second method, and when ACK feedback information is reported by the first method, additional shared allocation feedback information can be transmitted according to the second method.

FIGS. 3 and 4 are conceptual diagrams illustrating the first shared allocation feedback information transmitting method and second shared allocation feedback information transmitting method according to an exemplary embodiment of the present invention.

First, FIG. 3 illustrates a case in which the first shared allocation feedback information transmitting method is used (i.e., a PHICH is used).

Referring to FIG. 3, a base station transmits scheduling information on shared radio resources to a terminal (301), and the terminal transmits data using shared radio resources designated by the scheduling information (302).

The base station transmits an ACK or NACK signal indicating whether or not the data transmitted by the terminal is successfully received through a PHICH (303). When the data is successfully received (i.e., when the bases station transmits an ACK signal), the base station transmits information for designating the terminal which has transmitted the successfully received data to the terminal (304).

FIG. 4 illustrates a case in which the second shared allocation feedback information transmitting method is used (i.e., a physical uplink shared channel (PUSCH) region is used).

Referring to FIG. 4, a base station transmits scheduling information on shared radio resources to a terminal (401), and the terminal transmits data using shared radio resources designated by the scheduling information (402).

The base station transmits an ACK or NACK signal indicating whether or not the data transmitted by the terminal is successfully received and information for designating the terminal which has transmitted the successfully received data to the terminal together to the terminal (403).

The above-mentioned combination of the first and second methods denotes that it is possible not to transmit feedback information according to the second method (a transmission method using at least one of PDCCH and PDSCH regions) when NACK feedback information is reported by the first method (a transmission method using a PHICH), and to transmit additional shared allocation feedback information (information designating a terminal having successfully transmitted data) according to the second method (a transmission method using at least one of PDCCH and PDSCH regions) when ACK feedback information is reported by the first method (a transmission method using a PHICH).

When a base station transmits a NACK feedback using shared allocation feedback information according to the above-described methods, a terminal transmitting uplink data using the corresponding uplink shared allocation resources can immediately recognize that the uplink information transmitted by the terminal itself is not received by the base station. Also, the terminal may wait for uplink resources according to new shared allocation, request uplink radio resources using a previously set uplink control channel, or request uplink radio resources using a random access process.

On the other hand, when feedback information including ACK feedback information and the unique identifier of a terminal transmitted by the base station is received, the terminal may request additional uplink radio resources or perform a lower power consumption operation according to a buffer status of the terminal.

Example of Operation of Cellular System According to Present Invention

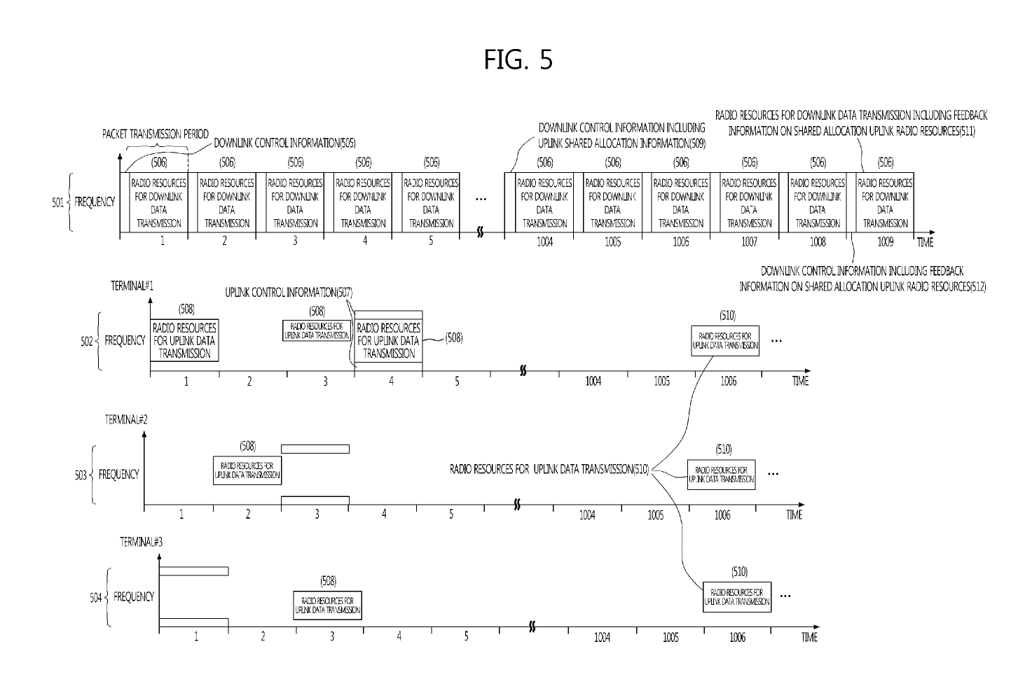

FIG. 5 is a frame timing diagram illustrating an uplink reception method of a base station and an uplink transmission method of a terminal according to an exemplary embodiment of the present invention.

FIG. 5 shows a timing diagram 501 of an uplink reception frame of a base station, and uplink transmission frame timing diagrams 502, 503 and 504 of terminal#1, terminal#2 and terminal#3 accessing the base station. The uplink transmission frame timing diagrams 502, 503 and 504 of terminal#1, terminal#2 and terminal#3 are illustrated with respect to the uplink transmission timing of each terminal (it is assumed that a distance between the base station and each terminal decreases in the order of terminal#3, terminal#2, and terminal#1). Uplink transmission frames of each terminal is aligned by timing adjustment in consideration of propagation delays between the base station and each terminal and received at the base station.

A timing relationship between a downlink and an uplink shown in FIG. 5 is merely an example, and a timing relationship between the downlink and the uplink including a difference in transmission time and a difference in reception time may vary according to the setting of a system.

Using downlink control information (a physical downlink control channel (PDCCH)) of a downlink, the base station transmits downlink scheduling information on radio resources 506 for downlink data transmission and uplink scheduling information for radio resources 508 for uplink data transmission for multiple terminals on an uplink.

Operation of the base station and terminals will be described below in order of uplink scheduling period. As described above, one scheduling period may be one subframe in 3GPP LTE, but a scheduling period in uplink transmission and reception using shared radio resources according to an exemplary embodiment of the present invention is not limited to one subframe.

1) Uplink Scheduling Period 1

Terminal#1 transmits packet information using radio resources 508 for uplink data transmission allocated according to uplink scheduling information in uplink control information 505.

Terminal#3 transmits uplink control information using a control field in uplink control information 507 allocated to terminal#3 itself according to a relationship with downlink radio resource allocation.

2) Uplink Scheduling Period 2

Terminal#2 transmits packet information using radio resources 508 for uplink transmission allocated according to the uplink scheduling information in the uplink control information 505.

3) Uplink Scheduling Period 3

Terminal#1 and terminal#3 transmit packet information using radio resources 508 for uplink transmission allocated according to the uplink scheduling information in the uplink control information 505.

Terminal#2 transmits uplink control information using a control field in uplink control information 507 allocated to terminal#2 itself according to a relationship with downlink radio resource allocation.

4) Uplink Scheduling Period 4

Terminal#1 transmits uplink control information using a control field allocated to terminal#1 itself in uplink control information 507 while transmitting packet information using radio resources 508 for uplink data transmission allocated according to the uplink scheduling information in the downlink control information 505.

5) Downlink Scheduling Period 5˜1003

Since there is no data received on a downlink or no uplink control information and packet data to be transmitted on an uplink for a time, terminal#1, terminal#2 and terminal#3 which have had no opportunity for uplink transmission monitor the downlink control information 505 continuously or according to the operation state of each terminal, that is, a low power consumption operation (DRX) period, a semi persistent scheduling (SPS) period, etc.

6) Downlink Scheduling Period 1004

The base station transmits downlink control information 509 including uplink shared allocation information using one of the above-described shared allocation schemes.

The terminals check the downlink control information 509 including uplink shared allocation information while monitoring downlink control information.

7) Downlink Scheduling Period 1006

Terminal#1, terminal#2 and terminal#3 can transmit control information or packet data on an uplink established using uplink shared allocation radio resources 510 allocated according to the downlink control information 509 including shared allocation information. Thus, when the uplink shared allocation radio resources 510 are scheduled using methods B) and C), a conflict or competition in which a plurality of terminals perform transmission using the same resources occurs as shown in FIG. 5.

Here, a terminal which can request uplink radio resources using the uplink control information may not perform uplink transmission using the uplink shared allocation radio resources 510 but may be allocated dedicated uplink radio resources to operate through a conventional process.

8) Downlink Scheduling Period 1009

The base station can report feedback information indicating whether uplink information, which is transmitted by the terminal using the uplink shared allocation radio resources 510 in scheduling period 1006, is successfully received using radio resources 511 for downlink data transmission including feedback information on shared allocation uplink radio resources, downlink control information 512 including feedback information on shared allocation uplink radio resources, or both of the radio resources 511 for downlink data transmission and the downlink control information 512.

As mentioned above, ACK/NACK feedback information on the corresponding uplink shared allocation radio resources may be transmitted by additionally using a channel for transmitting ACK/NACK feedback information on uplink transmission (e.g., a PHICH).

When a base station allocates uplink radio resources to terminals in sequence according to the sequential allocation scheme between the above-described uplink radio resource shared allocation schemes or allocates uplink radio resources to terminals according to method A) using a polling scheme, the uplink radio resources can be allocated without a conflict or competition between the terminals.

As described above, in uplink transmission based on shared allocation, an MCS for multiple terminals can be determined for scheduling without particular consideration of wireless environments of the terminals. When the inappropriate MCS is applied to a plurality of terminals and there is a competition between the terminals, it may be difficult to ensure reliability of a transmitted packet. Thus, a system may limit attributes of a packet transmitted using radio resources based on shared allocation. In other words, data packets which require high transmission QoS or time limit, packets on which automatic repeat request (ARQ) is not performed at the radio link control (RLC) layer, or important control messages may be limited not to be transmitted using shared allocation uplink radio resources.

Method of Constituting Shared Allocation Radio Resources According to Present Invention

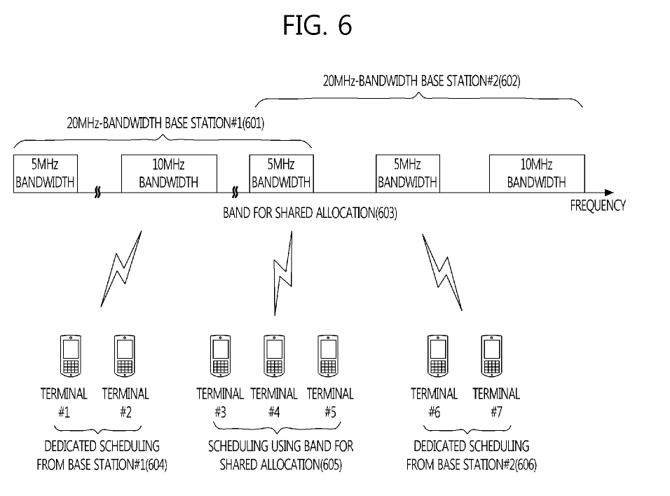

FIG. 6 is a conceptual diagram illustrating an example of the constitution of a system bandwidth including a band for shared allocation when the system bandwidth is constituted of fragmented bandwidths.

Base station#1 601 and base station#2 602 supporting a system bandwidth of 20 MHz may set a band 603 for shared allocation and allocate and manage uplink radio resources for sharing using the above-described scheme and process in the band 603. In this case, terminals may be classified into a group 604 for which base station#1 schedules dedicated uplink radio resources and which transmits information using the dedicated uplink radio resources, a group 606 for which base station#2 schedules dedicated uplink radio resources and which transmits information using the dedicated uplink radio resources, and a group 605 which performs uplink transmission using the shared allocation band 603 set by the two base stations according to a shared allocation scheme.

Unlike the example of the constitution shown in FIG. 6, base station#1 and base station#2 may designate not the same frequency band but separate frequency bands as shared allocation bands respectively.

Basically, a base station may apply shared allocation of uplink radio resources to the entire uplink bandwidth of the base station, or alternatively, a base station may apply shared allocation of uplink radio resources to a part of the uplink bandwidth. When an uplink bandwidth is constituted of fragmented bandwidths (carrier aggregation), a part of the fragmented bandwidths may be managed for shared allocation, or one or more base stations may manage a fragmented bandwidth or a part of the uplink bandwidth for shared allocation. In other words, a terminal transmits uplink resource request information or buffer status information using uplink radio resources or a control information format set by a system or base station without a random access process to the corresponding uplink radio resources, thereby having uplink radio resources allocated or transmitting uplink information using uplink radio resources allocated for sharing by the base station.

The above-mentioned base station is a transmission node constituting a radio interface with a terminal as an edge node of a cellular network, and may be one of a normal base station, small base station, home base station, remote base station, relay, and so on.

Uplink Reception Method of Base Station According to Present Invention

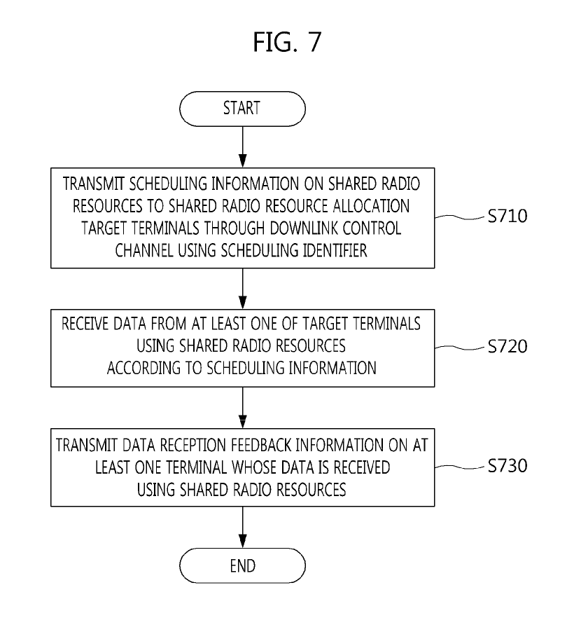

FIG. 7 is a flowchart illustrating an uplink reception method of a base station according to an exemplary embodiment of the present invention.

Referring to FIG. 7, an uplink reception method of a base station according to an exemplary embodiment of the present invention may include a scheduling information transmitting operation (S710), a data receiving operation (S720), and a feedback transmitting operation (S730).

First, in the scheduling information transmitting operation (S710), scheduling information on shared radio resources is transmitted to shared radio resource allocation target terminals through a downlink control channel using a scheduling identifier.

Shared radio resource allocation target terminals may denote terminals selected as targets to which data will be transmitted using shared radio resources by an uplink reception method according to an exemplary embodiment of the present invention. The shared radio resource allocation target terminals may be selected according to one of the conditions shown in Table 1 above or a combination of the conditions. Shared radio resources may be allocated to the selected terminals in sequence or randomly.

As described with reference to FIG. 4, base stations may set a shared allocation band in common and allocate and manage uplink radio resources for sharing, or may designate and manage different frequency bands as shared allocation bands respectively.

The entire uplink bandwidth of a base station may be used as a shared allocation band, or alternatively, the base station may limit the shared allocation band to a part of the uplink bandwidth. Also, when carrier aggregation is applied, shared radio resources may be managed for a part of component carriers, or one or more base stations may manage random component carriers or a part of the uplink bandwidth in common for shared allocation.

For the shared radio resources determined in this way, scheduling information may be transmitted to the selected shared radio resource allocation target terminals through a downlink control channel using a scheduling identifier.

At this time, the scheduling identifier may be determined to be one of the above-described three methods, that is, A) a method using a unique scheduling identifier allocated to a terminal, B) a method using a group scheduling identifier for multiple allocation intended for multiple terminals, and C) a method using a scheduling identifier informing of shared allocation (a scheduling identifier dedicated to shared allocation and set in advance to be used by the shared radio resource allocation target terminals in common).

Mapping/association relationships between one of a plurality of group scheduling identifiers for multiple allocation or a plurality of shared allocation scheduling identifiers and a terminal or a terminal group may be determined according to at least one of the attributes shown in Table 2.

Also, an MCS level to be applied to the target terminals receiving the scheduling information may be transmitted when the MCS level or the range of the MCS level is designated by the scheduling identifier using a mapping relationship between the scheduling identifier and the MCS level, or when the MCS level or the range is designated through a downlink control channel in which the scheduling information is transmitted.

Next, in the data receiving operation (S720), data is received from at least one of the target terminals, to which the scheduling information is transmitted in the preceding operation (S710), using the shared radio resources according to the scheduling information.

When the scheduling identifier is configured to indicate not a single MCS level but the range of an available MCS level of the data and the range of an available MCS level of the data is transmitted through a downlink control channel, the base station may receive the shared radio resources within the designated range of the MCS level and perform blind demodulation and decoding on the shared radio resources.

Finally, the uplink reception method according to an exemplary embodiment of the present invention may include the feedback transmitting operation (S730) in which data reception feedback information on at least one terminal whose data is successfully received is transmitted using the shared radio resources.

In the feedback transmitting operation (S730), the base station may transmit ACK/NACK information indicating the unique identifier of the terminal whose data is successfully received to the at least one terminal through a PHICH, or using at least one of a PDCCH region and a PDSCH region.

When the ACK/NACK information is transmitted using at least one of a PDCCH region and a PDSCH region, the ACK/NACK information may include identifier information on the terminal whose data is successfully received, and at least one piece of feedback control information on shared allocation may be transmitted by one piece of downlink feedback information. Such feedback control information may include at least one of pieces of information shown in Table 3 above.

Meanwhile, implicit feedback may be performed to reduce the signaling overhead of an ACK signal indicating that data is successfully received or a NACK signal indicating that data is not successfully received. For example, when data is successfully received, only an identifier designating a terminal having transmitted the data may be reported, and when data is not successfully received, neither an identifier nor a NACK signal is reported. Thus, when no feedback information is received, the terminal can implicitly know that the transmitted data is not normally received by the base station.

Uplink Transmission Method of Terminal According to Present Invention

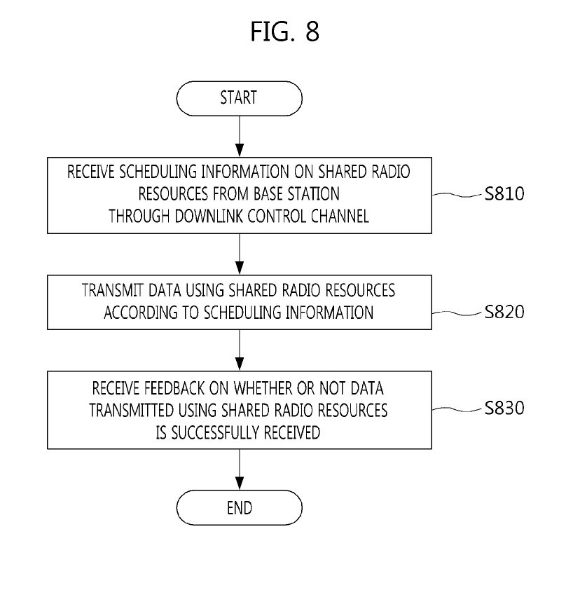

FIG. 8 is a flowchart illustrating an uplink transmission method of a terminal according to an exemplary embodiment of the present invention.

Referring to FIG. 8, an uplink transmission method of a terminal according to an exemplary embodiment of the present invention may include a scheduling information receiving operation (S810), a data transmitting operation (S820), and a feedback receiving operation (S830).

First, in the scheduling information receiving operation (S810), scheduling information for having shared radio resources allocated for uplink transmission is received from a base station through a downlink control channel using shared radio resources shared by at least one terminal. In other words, in the scheduling information receiving operation (S810), scheduling information transmitted by the base station is received in response to the scheduling information transmitting operation (S710) of the uplink receiving method of a base station described with reference to FIG. 7.

Terminals receiving scheduling information in the scheduling information receiving operation (S810) are shared radio resource allocation target terminals described above with reference to FIG. 7, denoting terminals selected as targets to which data will be transmitted using shared radio resources. The shared radio resource allocation target terminals may be selected as described above with reference to FIG. 7.

As described with reference to FIG. 4, base stations may set in advance a shared allocation band in common and allocate and manage uplink radio resources for sharing, or may designate and manage separate frequency bands as shared allocation bands respectively. The entire uplink bandwidth of a base station may be used as a shared allocation band, or alternatively, the base station may limit the shared allocation band to a part of the uplink bandwidth. Also, when carrier aggregation is applied, shared radio resources may be managed for a part of component carriers, or one or more base stations may manage random component carriers or a part of the uplink bandwidth in common for shared allocation.

The shared radio resources determined in this way may be designated to terminals through a downlink control channel using a scheduling identifier according to the scheduling information. At this time, the scheduling identifier may be determined to be one of the above-described three methods, that is, A) a method using a unique scheduling identifier allocated to a terminal, B) a method using a group scheduling identifier for multiple allocation intended for multiple terminals, and C) a method using a scheduling identifier informing of shared allocation (a scheduling identifier dedicated to shared allocation and set in advance to be used by the shared radio resource allocation target terminals in common).

Mapping/association relationships between one of a plurality of group scheduling identifiers for multiple allocation or a plurality of shared allocation scheduling identifiers and a terminal or a terminal group may be determined according to at least one of the attributes shown in Table 2.

Meanwhile, an MCS level to be applied to data to be transmitted in the data transmitting operation (S820), which will be described below, may be received when an MCS level or the range of the MCS level is designated by the scheduling identifier using a mapping relationship between the scheduling identifier and the MCS level, or when the MCS level or the range is designated through a downlink control channel in which the scheduling information is transmitted.

Next, in the data receiving operation (S820), data is transmitted using the shared radio resources according to the scheduling information. As mentioned above, an MCS level or the level of the MCS level may be designated to terminals by a scheduling identifier or information included in scheduling information included in a downlink control channel. When the range of an available MCS level is designated, a terminal may select an optimum MCS level according to the current channel environment of the terminal itself and transmit data using the selected MCS level. At this time, the base station needs to perform blind demodulation and decoding as in the data receiving operation (S720) described with reference to FIG. 7.

In the data transmitting operation (S820), each terminal may transmit the unique identifier given to the terminal itself together with data using the shared radio resources, thereby informing the base station that a terminal transmitting data using the shared radio resources is the terminal itself.

Finally, in the feedback receiving operation (S830), whether or not the data transmitted using the shared radio resources is successfully received is fed back from the base station.

The feedback receiving operation (S830) is a reception operation of a terminal corresponding to the feedback transmitting operation (S730) of the uplink reception method of a base station described above with reference to FIG. 7. Feedback information may be received from the base station through a PHICH or using at least one of a PDCCH region and a PDSCH region.

When a NACK signal is received through a PHICH, the NACK signal denotes that transmission of multiple terminals using the allocated shared radio resources causes a conflict between the terminals and hinders the base station from successfully receiving transmitted information, no terminal performs transmission using the corresponding uplink radio resources, or the base station cannot receive information transmitted by only one terminal. On the other hand, when an ACK feedback is received through a PHICH, control information indicating which terminal has transmitted the received information may need to be additionally received. Thus, a terminal using uplink radio resources allocated for sharing can check whether or not the base station successfully receives uplink information transmitted by the terminal itself

When feedback information is received using at least one of a PDCCH region or a PDSCH region, identifier information on a terminal whose data is successfully received as well as ACK/NACK information may be received from the base station, and at least one piece of feedback control information on shared allocation may be transmitted by one piece of downlink feedback information. Such feedback control information may include at least one of pieces of information shown in Table 3 above.

Exemplary embodiments of the present invention introduce the concept of shared allocation of uplink radio resources into packet-based cellular systems. Thus, processes such as an uplink radio resource request between a terminal and a base station, a buffer status report, and uplink radio resource allocation are integrated and reduced so that an uplink transmission delay can be reduced.

While the example embodiments of the present invention and their advantages have been described in detail, it should be understood that various changes, substitutions and alterations may be made herein without departing from the scope of the invention.

1. A method of allocating radio resources for uplink transmission and performing uplink reception using radio resources shared by at least one terminal, comprising:
a scheduling information transmitting operation of transmitting scheduling information on the shared radio resources to shared radio resource allocation target terminals through a downlink control channel using a scheduling identifier;
a data receiving operation of receiving data from at least one of the target terminals using the shared radio resources according to the scheduling information; and
a feedback transmitting operation of transmitting data reception feedback information on the at least one terminal of which the data is received using the shared radio resources.

2. The method of claim 1, wherein the scheduling identifier is one of a unique identifier given to each of the target terminals, a unique identifier allocated to a group of some of the target terminals, and an identifier reserved for shared allocation.

3. The method of claim 2, wherein the scheduling identifier indicates a modulation and coding scheme (MCS) level of data that the target terminals transmit using the shared radio resources or a range of the MCS level, or
the scheduling information includes information indicating the MCS level of the data that the target terminals transmit using the shared radio resources or the range of the MCS level.

4. The method of claim 3, wherein when the scheduling identifier indicates the range of the MCS level of the data transmitted using the shared radio resources, or the scheduling information includes the information indicating the range of the MCS level of the data transmitted using the shared radio resources, the data receiving operation includes performing blind demodulation and decoding on the received data from the shared radio resources within the range of the MCS level of the data.

5. The method of claim 1, wherein when the data is successfully received from the at least one terminal, the feedback transmitting operation includes transmitting a signal indicating that the data is successfully received from the at least one terminal using an ACK signal of a downlink physical hybrid automatic repeat request (HARQ) indicator channel (PHICH).

6. The method of claim 5, wherein the feedback transmitting operation further includes transmitting information for designating the terminal transmitting the successfully received data separately from the ACK signal of the downlink PHICH.

7. The method of claim 1, wherein when the data is successfully received from the at least one terminal, the feedback transmitting operation includes transmitting information for designating the terminal transmitting the successfully received data together with a signal indicating that the data is successfully received from the at least one terminal using at least one of a physical downlink control channel (PDCCH) region and a physical downlink shared channel (PDSCH) region.

8. A method for a terminal to have radio resources for uplink transmission allocated and perform uplink transmission using radio resources shared by at least one terminal, comprising:
a scheduling information receiving operation of receiving scheduling information on the shared radio resources from a base station through a downlink control channel using a scheduling identifier;
a data transmitting operation of transmitting data using the shared radio resources according to the scheduling information; and
a feedback receiving operation of receiving feedback on whether or not the data transmitted using the shared radio resources is successfully received from the base station.

9. The method of claim 8, wherein the scheduling identifier is one of a unique identifier given to the terminal, a unique identifier allocated to a plurality of terminals including the terminal, and an identifier reserved for shared allocation.

10. The method of claim 8, wherein the scheduling identifier indicates a modulation and coding scheme (MCS) level of data that the terminal transmits using the shared radio resources or a range of the MCS level, or
the scheduling information includes information indicating the MCS level of the data that the terminal transmits using the shared radio resources or the range of the MCS level.

11. The method of claim 8, wherein the data transmitting operation includes transmitting a unique identifier allocated to the terminal together with the data using the shared radio resources according to the scheduling information.

12. The method of claim 8, wherein when the data transmitted by at least one terminal is successfully received by the base station, the feedback receiving operation includes receiving the feedback from the base station using an ACK signal of a downlink physical hybrid automatic repeat request (HARQ) indicator channel (PHICH).

13. The method of claim 12, wherein the feedback receiving operation further includes receiving information for designating the terminal transmitting the successfully received data separately from the ACK signal of the downlink PHICH.

14. The method of claim 8, wherein when the data transmitted by at least one terminal is successfully received, the feedback receiving operation includes receiving, from the base station, information for designating the terminal transmitting the successfully received data together with a signal indicating that the data is successfully received from the at least one terminal using at least one of a physical downlink control channel (PDCCH) region and a physical downlink shared channel (PDSCH) region.
